(19) United States
(12) Patent Application Publication
(10) Pub. No.: US 2014/0282032 A1
(43) Pub. Date: Sep. 18, 2014

(54) DYNAMICALLY CONFIGURING USER EXPERIENCES WITH ACTION UNIFORM RESOURCE IDENTIFIERS

(71) Applicant: MICROSOFT CORPORATION, Redmond, WA (US)

(72) Inventors: Jared Brown, Kirkland, WA (US); Lee Dicks Clark, Seattle, WA (US); Jason Lee, Snohomish, WA (US); Shane Thomas Lile, Redmond, WA (US); Zhimin Yang, Bellevue, WA (US)

(73) Assignee: Microsoft Corporation, Redmond, WA (US)

(21) Appl. No.: 13/831,882

(22) Filed: Mar. 15, 2013

(51) Int. Cl. G06F 3/0484

(52) U.S. Cl. CPC G06F 3/0484
USPC 715/738

(57) ABSTRACT

An action uniform resource identifier (URI) is sent from a web service to a user device in response to a request from the user device. The action URI identifies at least one native task for execution by the user device. The task, when executed, interacts with at least one resource local to the user device. The received action URI is provided by the user device to an application to perform the task involving the local resource. The response may include hosted UI elements not available on the user device. The hosted UI elements enable presentation of new data types on the user device, which may not be adequately presented using pre-defined UI templates. The hosted UI elements interact with elements of the pre-defined UI templates to generate new UI layouts. The action URIs and hosted UI elements are provided and execute without replacing already-installed application code.

### BACKGROUND

In some existing systems, servers provide updates to operating systems and native applications installed on devices such as mobile computing devices. For example, a browser on the mobile computing device displays a link to a website of the server having the updated functionality. By following the link, a user obtains code to modify or update the native code associated with one or more of the installed applications. In another example, the server pushes the updated code to the mobile computing device. These manners of updating, however, require updates to the installed, or native code of the applications to be updated and, for some systems, the entire installed application must be re-installed. This often consumes a significant amount of bandwidth, storage, processing power, and time, thus providing the user with a disjointed update experience.

### SUMMARY

In embodiments of the disclosure, a user computing device receives user input from an application executing on the user computing device. A request describing the received user input is sent to a web service. In response to receiving the request, the web service sends to the user computing device at least one action uniform resource identifier (URI). The action URI identifies one or more native tasks for execution by the user computing device. The one or more native tasks specify at least one resource local to the user computing device to be involved with performance of the native tasks. The received action URI is provided by the user computing device to the application. The application performs the one or more native tasks involving the local resource.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an exemplary block diagram illustrating a user computing device (e.g., a mobile computing device) in communication with a web service via a network.

FIG. 2 is an exemplary flow chart illustrating operation of the user computing device to perform actions based on the action uniform resource identifiers (URIs) received from a web service.

FIG. 3 is an exemplary flow chart illustrating operation of the web service to perform actions based on the request received from the user computing device.

FIG. 4 is an exemplary block diagram illustrating a server computing device of the web service interacting with the user computing device.

FIG. 5 is an exemplary architecture of the server computing device and the user computing device.

FIGS. 6A and 6B show exemplary flow charts illustrating operations performed by the user computing device using a hosted online search experience (HOSE) as an addition to a conventional search application when invoking action URIs.

FIG. 7 is an exemplary user interface illustrating sample results from performance by the user computing device of the operations illustrated in FIGS. 6A and 6B.

FIG. 8 is an exemplary block diagram illustrating interaction of the user computing device with the web service to produce sample results displayed on the user computing device.

Corresponding reference characters indicate corresponding parts throughout the drawings.

### DETAILED DESCRIPTION

Referring to the figures, embodiments of the disclosure provide an enhanced user experience to a user 108 of a user computing device 102 or other user device. The user computing device 102 receives information from a web service 104 indicating which user interface (UI) template 120 to use when the user 108 interacts with the user computing device 102. A plurality of UI templates 120 is stored on the user computing device 102. As the user computing device 102 receives input from the user 108, a request describing the user input is sent to the web service 104. The web service 104 sends to the user computing device 102 at least one action uniform resource identifier (URI) or indicator that indicates a native task to be performed using an application 114 (and UI template 120 in some embodiments) available on the user computing device 102, without modifying the installed code associated with the version of the application stored by the user computing device 102 (e.g., without replacing or overwriting any of the existing code).

In some embodiments, the web service 104 sends, along with the action URIs, hosted UI elements that are not available on the user computing device 102. The hosted UI elements present additional data types on the user computing device 102 that may not be adequately presented using the UI templates 120. The hosted UI elements interact seamlessly with the elements of the native UI template as directed by the action URIs, such as to generate new UI layouts and enhancements without updating the installed code associated with the application being launched or otherwise executed. Aspects of the disclosure provide a rich user experience without notifying the user 108 of the action URIs or the hosted UI elements.

Because the action URIs and hosted UI elements specified by the web service 104 may change and evolve with time, the user experience also changes and evolves with time. Thus, the user experience always remains current or otherwise up-to-date without the user 108 taking any manual action to update the application or even being aware of the operations to update the user experience, in some embodiments.

Referring next to FIG. 1, an exemplary block diagram illustrates the user computing device 102 in communication with the associated web service 104 via a network 106. In the example of FIG. 1, the user computing device 102 associated with the user 108 represents a system for server-driven user interface interaction with resources native to the user computing device 102. The user computing device 102 represents any device executing instructions (e.g., as application programs, operating system functionality, or both) to implement the operations and functionality described herein. The functionalities described herein or other functionalities not specifically described herein may be activated via gesture recognition, touch recognition, and/or voice recognition features available on the user computing device 102 in addition to other ways such as usage of a keyboard and/or a pointing device or may be inferred from the position or orientation of the device or changes thereof. The user computing device 102 may include a mobile computing device or any other portable device. In some embodiments, the mobile computing device includes a mobile telephone, laptop, tablet, computing pad, netbook, gaming device, a wearable computing device such as in a watch or glasses form factor, and/or portable media player. The user computing device 102 may also include less portable devices such as desktop personal computers, kiosks, and tabletop devices. Additionally, the user computing device 102 may represent a group of processing units or other computing devices.

The user computing device 102 has a memory area 112 associated therewith. The memory area 112 includes any quantity of media associated with or accessible by the user computing device 102. The memory area 112 may be internal to the user computing device 102 (as shown in FIG. 1), external to the user computing device 102 (not shown), or both (not shown). In some embodiments, the memory area 112 includes read-only memory and/or memory wired into an analog computing device.

The memory area 112 stores, among other data, one or more applications 114. The applications 114, when executed by a processor 110, operate to perform functionality on the user computing device 102. Exemplary applications 114 include mail application programs, web browsers, calendar application programs, address book application programs, messaging programs, media applications, gaming applications, map applications, location-based services, search programs, and the like. The applications 114 may communicate with counterpart applications or services such as the web service 104 accessible via the network 106. For example, the applications 114 may represent downloaded client-side applications that correspond to server-side services executing in a cloud.

The network 106 includes any wired and/or wireless network over which one or more protocols may be implemented. Embodiments of the network 106 contemplate various configurations of wired and/or wireless networks. The network 106 supports, for example, local area networks, peer-to-peer communication, and client-server communication.

The memory area 112 further stores a set of blocked action URIs 116 and a set of allowed action URIs 118. The set of blocked action URIs 116 identifies the tasks that are prohibited from execution by the user computing device 102. The set of allowed action URIs 118 identifies the tasks that are allowed to be executed by the user computing device 102. The two sets may contain information received from the web service 104, from the user computing device 102, and/or from the user. For example, the web service 104 may identify tasks and/or applications that are safe to be executed, that are allowed to be executed based on the current privileges, and/or conform to the user's digital rights management (DRM). This information may be included in the set of allowed action URIs 118.

The set of allowed URIs 118 may also include first party and third party applications that are allowed to be launched on the user computing device 102. This information may be updated periodically or at pre-defined intervals by the web service 104. The update may include a current version of the application and limits on the number and size of parameters that can be safely used while launching or otherwise executing an application. The version of the application and validation of the parameters may be done by the user computing device 102 before launching an application. The set of blocked action URIs 116 may include information received from the web service 104 or from the user computing device 102 indicating a number and a length of parameters that exceed the limits of the number and the length of the parameters that can be used in a function executing on the user computing device 102 without long processing delays, system hangs, or crashes. For example, while executing a map application on the user computing device 102, if the application tries to execute a function having a large number of parameters and/or the length of the parameters matches or exceeds the limits given in the set of blocked action URIs 116, an “unsafe to execute” message may be presented to the user 108 without executing the function. For example, the set of blocked action URIs 116 may contain periodically updated information about man-in-the middle attacks on the user computing device 102. The blocked action URIs 116 may also contain information about privacy settings and private data of the user 108 that are denied access by another party or application.

The memory area 112 also stores the UI templates 120. The UI templates 120 may provide hypertext markup language (HTML), cascading style sheets (CSS), and/or JAVASCRIPT brand software elements and graphics for the user interface to be used for an application 114 being launched or otherwise being executed on the user computing device 102. The UI templates 120 may define a layout of the UI elements that may be customized for specific applications 114 executing on the user computing device 102. For example, the UI templates 120 may have designated locations for headings, sub-headings, font and size of texts to be used, designated locations for graphics, its colors, its resolutions and the like. The actual values received for the UI elements in a response from the web service 104 are used to display the received information using an appropriate UI template that aptly displays the received information. The UI templates 120 may be amenable to integrating additional HTML, CSS, and/or JAVASCRIPT brand software elements seamlessly without any user action. The UI templates 120 may be supplied by the developers of the applications 114. The UI templates 120 may be updated over time based on information received from the web service 104 without any action being taken by the user 108.

The user computing device 102 further has at least one processor 110 associated therewith. The processor 110 includes any quantity of processing units, and is programmed, in some embodiments, to perform at least the functions as depicted in FIG. 2 and/or FIGS. 6A and 6B. The functions may be performed by the processor or by multiple processors executing within the user computing device 102, or performed by a processor external to the user computing device 102.

In some embodiments, the processor 110 represents an implementation of analog techniques to perform the operations described herein. For example, the operations may be performed by an analog computing device and/or a digital computing device.

Exemplary operations are described further with reference to FIG. 2 below, and include receiving user input from the user 108 of the user computing device 102, sending a request describing the user input to the web service 104, and receiving from the web service 104 at least one action URI identifying at least one corresponding native task that specifies at least one resource local to the user computing device 102. The local resource may be any resource local to the user computing device 102 including virtual resources. The resources include all hardware and virtualized hardware such as a graphic processing unit, sound card, network interface card, speaker, microphone, camera, accelerometer, gyroscope, location sensor, battery, and other various devices connected to ports and the like. Resources include volatile, non-volatile, removable, and/or non-removable memories. The memory area 112 may be part of the memories and store data as shown in FIG. 1, as well as other data not shown. One or more of the resources available to the user computing device 102 may be specified by the native task identified in the action URI received from the web service 104 and may include memory area 112.

The processor 110 is further programmed to provide the received action URI to at least one of the plurality of applications 114 executing on the user computing device 102. In embodiments of the disclosure, the user computing device 102 confirms, before executing, activating, or otherwise implementing the received action URI, that the received action URI is not present in the set of blocked action URIs 116 and/or confirms that the received action URI is present in the set of allowed action URIs 118. After the confirmation, the user computing device 102 performs the one or more corresponding native tasks involving the at least one local resource.

Referring next to FIG. 2, the exemplary flowchart illustrates operation of the user computing device 102 to perform actions based on the action URIs received from the web service 104. While the operations illustrated in FIG. 2 are described as being performed by the user computing device 102 in some embodiments, the operations may be performed by any other computing entity such as a cloud service or a web service.

At 202, the user computing device 102 checks if the user input has been received. If the user input has been received, the user computing device 102 sends a request describing the user input to the web service 104 at 204. The description of the user input may include, for example, a query, HTML details, device metadata, identification of an operating system (OS) of the user computing device 102, and/or other data such as location data and the like. At 206, the user computing device 102 receives a response from the web service 104. The response includes, for example, one or more action URIs. The action URIs identify one or more corresponding native tasks for execution by the user computing device 102. The native tasks specify one or more resources local to the user computing device 102. The response may employ, for example, HTML 5, OS-specific CSS, and OS-specific JAVASCRIPT brand software. The response may also include metadata for the JAVASCRIPT brand software and placeholders for native data. The JAVASCRIPT brand metadata may be used for interaction with the native components.

In some embodiments, the actions of sending the request to the web service and receiving action URIs remains transparent to the user 108. At 208, the user computing device 102 checks whether the received action URIs are present in the set of blocked action URIs 116. If any of the received action URIs is present in the set of blocked action URIs 116, the user input is not further processed and an access denied message is displayed on the user computing device 102 at 210. In this manner, aspects of the disclosure provide a security model that blocks or otherwise prevents actions (or other client-side behaviors) identified as prohibited from execution by the user computing device 102, as described herein.

If none of the received action URIs are present in the set of blocked action URIs 116, the user computing device 102 further checks, at 212, whether the received action URIs are present in the set of allowed action URIs 118. If any of the received action URIs is not present in the set of allowed action URIs 118, the user input is not further processed and an access denied message is displayed on the user computing device 102 at 210. If the received actions URIs are present in the set of allowed action URIs 118, then the received actions URIs and other information contained in the response are provided to one of the applications 114 at 214. The application performs one or more native tasks identified by the received action URIs, while using the local resources specified by the native tasks.

The user computing device 102 may compare the received action URIs to either or both of the sets of action URIs. In one example, the user computing device 102 searches for the received action URIs in the set of blocked action URIs 116, but not in the set of allowed action URIs 118. In another example, the user computing device 102 searches for the received action URIs in the set of allowed action URIs 118, but not in the set of block action URIs 116.

In some of the embodiments, the local resources specified by the native tasks may define a UI template 120 to be used to present the results of execution of the application. In other embodiments, when a UI template 120 is not adequate for presentation of the data types received with the action URIs, the action URIs may include hosted UI elements that are not natively available on the user computing device 102. The included hosted UI elements interact seamlessly with the elements of a selected UI template 120 without updating installed code associated with the application 114 and/or without re-installing the application 114 executing on the user computing device 102. Thus, aspects of the disclosure provide a user experience that remains in consonance with the current data types received from the web service 104, while at the same time not modifying any of the installed client side code (e.g., without overwriting or re-installing the application).

Referring next to FIG. 3, the exemplary flowchart illustrates the operation of the web service 104 to perform actions based on the request received from the user computing device 102. While the operations illustrated in FIG. 3 are described as being performed by the web service 104 in some embodiments, the operations may be performed by any other computing entity such as a cloud service or another computing device in proximity to or in connection with the user computing device 102. At 306, the web service 104 checks if a request, received from the user computing device 102, includes a state of the user computing device 102. The state of the user computing device 102 may include the state of applications 114 running on the user computing device 102 and the UI templates 120 available on the user computing device 102. For example, the state of other applications may indicate if a text file can be rendered on the user computing device 102 as speech employing a text-to-speech application available on the user computing device 102 using a speaker of the user computing device 102 that is currently on but not in use. If the state, for example, indicates that speaker is currently in use by an audio file being processed by the sound card, then only a text message may be sent. The state may, for instance, indicate that an artificial intelligence engine available on the user computing device 102 can be used for a gaming application and a suitable UI template 120 can be used for animation. The state of the user computing device 102 may, for example, indicate the current battery level of the user computing device 102.

The request may include a query, a flag indicating HTML details and metadata relating to the user computing device 102, a state of the user computing device 102, an identification of the OS of the user computing device 102, and/or other data. If the request includes a state of the user computing device 102, at 308 one or more action URIs are identified based at least on the state of the user computing device 102. The state of the user computing device 102 may include an indication of the status of a resource local to the user computing device 102. At 310, the identified action URIs and other information are provided to the user computing device 102 thereby enabling the user computing device 102 to execute tasks corresponding to the provided action URIs. Execution of the tasks may involve at least one resource local to the user computing device 102. For example, if the state of the user computing device 102 indicates the status of the battery of the user computing device 102 as having reached a lower threshold, one of the tasks for execution may be to initiate battery conservation measures.

Referring next to FIG. 4, an exemplary block diagram illustrates a server computing device 416 of the web service 104 interacting with the user computing device 102. In some embodiments, the web service 104 is hosted on the server computing device 416, as shown for example in FIG. 4. The server computing device 416 includes, among other features, one or more computer-readable storage media such as memory area 404 that stores computer-executable components that, when executed by a processor 402, perform actions as described herein. The processor 402 may include one or more processing units and may be internal or external to the server computing device 416. The processing units may be analog or digital processing units or a combination of both.

Exemplary computer-executable components include a link component 406, a communications interface component 408, a configuration component 410, a restrictor component 412, and a report component 414, among others.

The link component 406, when executed, causes the processor 402 to define a plurality of action URIs. Each of the action URIs corresponds to a task to be executed by the user computing device 102, where the task involves at least one resource local to the user computing device 102.

The communications interface component 408, when executed, causes the processor 402 to receive a request from the user computing device 102. The request includes a state of the user computing device 102. The state may be conveyed in, for example, HTTP request headers. The request may further include a query, flags indicating HTML details, the user computing device 102 metadata, an identification of the OS of the user computing device 120, and/or other data such as location data. Further, the communications interface component 408 provides a response to the user computing device 102 that includes the set of allowed action URIs 118 and/or the set of blocked URIs 116. The set of allowed action URIs 118 identifies the tasks that are allowed to be executed by the user computing device 102. The set of blocked action URIs 116 identifies the tasks that are prohibited from execution by the user computing device 102.

In some embodiments, the communications interface component 408 includes a network interface card and/or computer-executable instructions (e.g., a driver) for operating the network interface card. Communication between the server computing device 416 and other devices may occur using any protocol or mechanism over any wired or wireless connection. In some embodiments, the communications interface component is operable with near-field communication (NFC) tags. The term “NFC” as used herein refers, in some embodiments, to a short-range high frequency wireless communication technology for the exchange of data over short distances.

The configuration component 410, when executed, causes the processor 402 to identify, based on at least the state of the user computing device 102, one or more of the plurality of action URIs defined by the link component 406. Additionally, the communications interface component 408, while being executed, provides the one or more of the plurality of action URIs identified by the configuration component 410 to the user computing device 102. The user computing device 102, on being provided the identified one or more of the plurality of action URIs, executes the tasks corresponding to the one or more of the plurality of action URIs. Execution of the tasks involves at least one resource that was identified in the action URI and is local to the user computing device 102. For example, the tasks may read from a memory or write to a memory, use a network interface card, a graphic processing unit, a sound card, a speaker, and the like. The user computing device 102 operates to ensure that any task corresponding to a received action URI that is present in the set of blocked action URIs 116 is not executed, and only those tasks that are present in the set of allowed action URIs 118 are executed.

Further, in some embodiments, the restrictor component 412, when executed, causes the processor 402 to ensure that any parameters provided with the response do not exceed pre-defined limits, such as limits on the number of provided parameters and/or length of each provided parameter. Restricting the number of parameters and/or the length of each parameter ensures that the response provided to the user computing device 102 does not exceed the capacity of the user computing device 102 to process the provided parameters values and/or does not result in excessively long processing time. For example, in a map application, some exemplary parameters may be a center of the map, a zoom value of the map, latitude, longitude and elevation of a point on the map, location details, etc. The limit of precision to which each parameter is defined while providing argument values for the parameters may also be set. For example, the latitude may be defined as “N” or “S” and the value may be in degrees, degrees and minutes, or degrees, minutes and seconds. The limit on the number of parameters may include maximum number of parameters used to describe location details.

The limit of the number of parameters represents a maximum number of parameters that may be provided in a response. The limit on the length of each parameter represents a maximum number of characters in any parameter. In some embodiments, the limits may be pre-defined. In other embodiments, the limits may be dynamically set based on the state of the user computing device 102 and network 106 conditions such as currently available bandwidth.

In some embodiments, the report component 414, when executed, causes the processor 402 to receive data via communications interface component 408. The data indicates the result from the user computing device 102 of execution of the tasks corresponding to the response from the server computing device 416. In some embodiments, the result may include data indicating whether the provided action URIs were found valid and the corresponding tasks were successfully executed, or the provided action URIs were found invalid and an access denied message was displayed by the user computing device 102.

Referring next to FIG. 5, a block diagram illustrates an exemplary architecture of the server computing device 416 and the user computing device 102. The user computing device 102 has a web search client 508 installed. The exemplary web search client 508 includes a configuration update module 510 and a validate action URIs module 512. The operation of these modules is described below.

The user computing device 102 further has a device memory area 112 that includes the set of blocked action URIs 116, the set of allowed action URIs 118, and a plurality of the installed applications 114, as also illustrated in FIG. 1.

The user computing device 102 is in communication with an associated web service 104. The web service 104 is hosted on the server computing devices 416. The web service 104 includes a configuration module 502, a search module 504, and an applications store 506. The operation of these components is next described.

In operation, the configuration module 502, either periodically or upon receiving a request from the user computing device 102, sends to the configuration update module 510 a configuration file that includes a current set of allowed action URIs 118 and a current set of blocked action URIs 116. The configuration file may be a config.xml file, for example. The configuration file may be sent via a secure protocol such as a hypertext transfer protocol secure (https). The configuration update module 510, immediately after receiving the configuration file or at pre-defined intervals, updates the set of blocked action URIs 116 and the set of allowed action URIs 118. In some embodiments, one or more of the applications 114 on the user computing device 102 are launched only after the validate action URIs module 512 checks and confirms that any action URIs included in the response from the web service 104 are not present in the blocked action URIs set 116 but are present in the allowed action URI set 118.

Upon interaction by the user 108 with the user computing device 102, a request is sent to the search module 504 using a protocol such as a hypertext transfer protocol (http). In some embodiments, the request may include the current state of the user computing device 102. Response to the request is provided by the search module 504, and may include action URIs and other data to provide a user experience consistent with the current state of the user computing device 102. The response includes, for example, hosted content and hosted UI elements, defined via HTML, CSS and/or JAVASCRIPT brand software that are based at least on the current state of the user computing device 102. The HTML version used may be HTML 5. The CSS and JAVASCRIPT brand software may be specific to the OS of the user computing device 102. The defined elements in the HTML, CSS and/or JAVASCRIPT brand software may include instructions that enable the current state of the user computing device 102 to influence the look, feel, and behavior of the hosted content when rendered on the user computing device 102. For example, if the hosted content uses one of the applications 114 for presentation on the user computing device 102 and the application 114 is not currently installed on the user computing device 102, the user may be prompted to download the application 114 from the applications store 506.

After the validate action URIs module 512 has validated the received action URIs, the application 114 is launched that corresponds to the received action URIs and other information received in the response from the web service 104. In some embodiments, the response includes hosted UI elements that are not available natively on the user computing device 102. In such embodiments, the hosted UI elements interact seamlessly with elements of a selected UI template 120. The interaction dynamically configures the native user interface to suit the presentation of both hosted content and native content without modifying code associated with an installed version of the application 114 and/or without re-installing the application 114.

Referring next to FIGS. 6A and 6B, exemplary flowcharts illustrate operations performed by the user computing device 102 using a hosted online search experience (HOSE) as an addition to a conventional search application. While the operations illustrated in FIGS. 6A and 6B are described as being performed by the user computing device 102 in some embodiments, the operations may be performed by any other computing entity such as a cloud service or a web service.

In the embodiments shown in FIGS. 6A and 6B, some example categories of search areas are presented in the form of icons or tiles to the user 108 on the user computing device 102. Clicking on one of the tiles associated with the HOSE returns results related to the specified category. The results are returned from the web service 104 in the form of thumbnails presented on the user computing device 102. Clicking on the thumbnails fetches detailed search results relating to the information given in the thumbnail.

Further, in this embodiment, a list of launch protocols related to first party applications that are acceptable to launch directly is registered with the OS shell of the user computing device 102. If an action URI received from the web service 104 matches one of the registered launch protocols, the action URI is acted upon by invoking an appropriate application programming interface (API). Invocation occurs after checking the validity of the received action URIs against the set of blocked action URIs 116 and the set of allowed action URIs 118.

The action URIs are received by the user computing device 102 at 650. The received action URIs are checked at 602 and 606 to ensure that the action URIs are not present in the set of blocked action URIs 116 and to confirm that the action URIs are present in the set of allowed action URIs 118. If the above conditions are not satisfied, an API “access denied” is called at 604. Calling the API stops further processing by the user computing device 102, and a denial of access message is presented on the user computing device 102. If the above conditions are satisfied, then at 612 the user computing device 102 checks whether the received action URIs match one of the registered launch protocols. If the received action URIs match one of the registered launch protocols, an API “navigation launch session (URI)” is called at 608 that launches a first party application out of the applications 114 stored on the user computing device 102.

If the received actions URIs do not match one of the registered launch protocols, a check is done by the user computing device 102 at 624 to determine whether the received action URIs relate to an application, a web service or others. If the received action URIs relate to an application out of the application 114, an application handler module 628 is used. At 630, the user computing device 102 checks whether the URI format is supported. If the URI format is supported, the user computing device 102 checks at 634 whether the application, referenced by the received action URIs, is installed. If the application is not installed, the user is prompted at 642 to download and install the application. If the application is installed, the user computing device 102 checks at 636 if the application is a third party application. If the application is a third party application, the user computing device 102 checks at 638 if the specific version of the installed application is permitted to be launched. If the version of the installed application is correct, the user computing device 102 checks at 640 if the parameters being used in the application do not exceed the limits of the number of parameters and/or the length of parameters specified for the application. If the application passes the parameter validation check, the “navigation launch session (URI)” API is called at 608 to launch or otherwise execute the application.

If the result of checking at any of operations 630, 636, 638 or 640 is negative, the “access denied” API is invoked at block 604. Further, if the result of checking protocol type at block 624 results in protocol type as “others”, the “access denied” API is invoked at block 604.

If the protocol check at block 624 indicates reference to the web service 104, a web service handler module 610 is used. At block 614, the domain of the received action URI is determined. At 616, it is checked if the domain is HOSE or search navigation. If the domain is a HOSE domain, a “navigation launch session (HOSE)” API is invoked at block 618 to launch an appropriate hosted online search application. If the domain includes a conventional search application, a “navigation launch session (NAV TARGET)” API is invoked at 620 to launch a search navigation application. The target may be a target on the Internet such as movies, for example. The navigation target of the search navigation may also be a first party application that is not registered with the OS shell of the user computing device 102. Launching an unregistered first party application in this embodiment is thus performed via the web service 104, and the received action URIs may include hosted UI elements. The hosted UI elements interact seamlessly with the elements of a native UI template indicated by the action URIs as discussed above.

Referring next to FIG. 7, an exemplary user interface illustrates sample results from performance by the user computing device 102 of the operation illustrated in FIGS. 6A and 6B. FIG. 7 depicts exemplary tiles “local search 720” and “see more results 722.” Examples of thumbnails of a subsection of “local search 720” named “local events” are shown as thumbnails “event 1”, “event 2” and “event 3” at 704, 706 and 708 respectively. Examples of thumbnails of another subsection of “local search 720” named “local apps” are shown as “app 1”, “app 2” and “app 3” at 710, 712 and 714 respectively. Tiles relating to “shopping 716” and “media 718” are shown under the heading of “see more results 722.” If one or more of these tiles is clicked, results similar to those shown for “local events” and “local apps” are depicted.

Referring next to FIG. 8, a block diagram illustrates interaction of the user computing device 102 with the web service 104 to produce sample results displayed on the user computing device 102. FIG. 8 shows the user computing device 102 to be a mobile telephone 808 in communication with the web service 104 to produce exemplary results on the UI 806. In this example, the user 108 enters a search query in a space 810 provided by a search application executing on the mobile telephone 808. The mobile telephone 808 sends a request that includes the query, a flag indicating HTML details, metadata of the mobile telephone 808, an identification of its OS, the state of the mobile telephone 808, its location data, etc., to the web service 104. The state of the mobile telephone 808 may include the state of other applications running on the mobile phone 808 and the UI templates 120 available on the mobile telephone 808. For example, the state of other applications may indicate whether a media player is capable rendering a media file in high definition or standard definition, and/or whether a text file can be rendered on the mobile telephone 808 in speech form using a text-to-speech conversion application available on the mobile telephone 808 with a speaker of the mobile telephone 808. The state of the mobile telephone 808 may, for example, indicate that the user is at present in a meeting and accepting text messages only.

An exemplary data stream showing some of the elements contained in the request sent from the mobile telephone 808 to the web service 104 is shown at 802. The exemplary data stream may contain the query, a flag indicating the HTML details, HTTP request headers (e.g., conveying the state of the mobile telephone 808), metadata of the mobile telephone 808, an identification of the OS of the mobile telephone 808, and/or other signals such as location data.

The web service 104 analyses the query in the light of other information contained in the data stream 802, to prepare a response that is in conformity with the query and the other information sent by the mobile telephone 808. For example, the response may be commensurate with the state of the mobile telephone 808 including the state of other applications executing on the mobile telephone 808, the templates for native UIs, the location data, etc. Thus, the response may include action URIs and/or hosted UI elements for use by an application running on the mobile telephone 808 for presentation of data types included in the response. For example, the response may include HTML 5, OS-specific CSS and/or OS-specific JAVASCRIPT brand software data that corresponds to hosted UI elements.

An exemplary data stream, showing some of the elements contained in the response sent from the web service 104 to the mobile telephone 808, is shown at 804. The exemplary data stream 804 may contain HTML 5, CSS and/or JAVASCRIPT brand software data, place holders for the elements of the native UI templates of the mobile telephone 808, and hosted UI elements. Upon receipt of the response, the mobile telephone 808 displays the information received from the web service 104 in a UI 806 on the mobile telephone 808.

### Additional Examples

At least a portion of the functionality of the various elements in FIG. 1, FIG. 2, FIG. 5, and/or FIG. 8 may be performed by other elements in the figures, or an entity (e.g., processor, web service, server, application program, computing device, etc.) not shown in the figures.

In some embodiments, the operations illustrated in FIG. 2, FIG. 3, FIG. 6A, and FIG. 6B may be implemented as software instructions encoded on a computer readable medium, in hardware programmed or designed to perform the operations, or both. For example, aspects of the disclosure may be implemented as a system on a chip.

In some embodiments, most recently updated (MRU) data from the set of blocked action URIs 116 and the set of allowed action URIs 118, as shown in FIG. 1 and FIG. 5, is loaded into cache memory of the user computing device 102 to reduce latency and improve the speed of processing. This may be done in parallel with updating the respective sets.

In some embodiments, only differential data relating to the set of blocked action URIs 116 and the set of allowed action URIs 118 is downloaded to conserve data usage via the network 106 when an update of the set of blocked action URIs 116 and the set of allowed action URIs 118 occurs.

In some embodiments, the user computing device 102 sends user identification data to the web service 104 and the web service 104 responds only when the user identification data matches with the identification data stored with the web service 104. The user identification data may comprise a user identifier and a password. Other forms of more secure identification methods may be used such as filling a form initially sent by the web service 104 over a secure channel and sending the completed form back to the web service 104 over the secure channel.

### Exemplary Operating Environment

Exemplary computer readable media include flash memory drives, digital versatile discs (DVDs), compact discs (CDs), floppy disks, and tape cassettes. By way of example and not limitation, computer readable media comprise computer storage media and communication media. Computer storage media include volatile and nonvolatile memories, removable and non-removable memories implemented in any method or technology for storage of information such as computer readable instructions, data structures, program modules and other data. Computer storage media are tangible and mutually exclusive to communication media. Computer storage media exclude propagated data signals. In some embodiments, computer storage media are implemented in hardware. Exemplary computer storage media include hard disks, flash drives, and other solid-state memories. In contrast, communication media typically embody computer readable instructions, data structures, program modules, or other data in a modulated data signal such as a carrier wave or other transport mechanism and include any information delivery media.

Although described in connection with an exemplary computing system environment, embodiments of the disclosure are operational with numerous other general purpose or special purpose computing system environments or configurations. Examples of well-known computing systems, environments, and/or configurations that may be suitable for use with aspects of the disclosure include, but are not limited to, mobile computing devices, including wearable computing devices, for example, in watch or glasses form factors, personal computers, server computers, hand-held or laptop devices, multiprocessor systems, gaming consoles, microprocessor-based systems, set top boxes, programmable consumer electronics, mobile telephones, network PCs, minicomputers, mainframe computers, distributed computing environments that include any of the above systems or devices, and the like.

Embodiments of the disclosure may be described in the general context of computer-executable instructions, such as program modules, executed by one or more computers or other devices. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions or the specific components or modules illustrated in the figures and described herein. Other embodiments of the disclosure may include different computer-executable instructions or components having more or less functionality than illustrated and described herein.

Aspects of the disclosure transform a general-purpose computer into a special-purpose computing device when configured to execute the instructions described herein.

The embodiments illustrated and described herein as well as embodiments not specifically described herein but within the scope of aspects of the disclosure constitute exemplary means for dynamically configuring a user interface of the user computing device 102 using data from the web service 104.

Further, the embodiments illustrated and described herein as well as embodiments not specifically described herein but within the scope of aspects of the disclosure, additionally constitute exemplary means for allowing the web service 104 to configure user interface interaction on the user computing device 102 without re-installing installed code associated with the at least one of the plurality of applications 114 executing on the user computing device 102.

The order of execution or performance of the operations in embodiments of the disclosure illustrated and described herein is not essential, unless otherwise specified. That is, the operations may be performed in any order, unless otherwise specified, and embodiments of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system for server-driven user interface interaction with resources native to a client device, said system comprising:
a memory area associated with a mobile computing device, said memory area storing a set of blocked action uniform resource identifiers (URIs), the memory area further storing a plurality of applications; and
a processor programmed to:
receive user input from a user of the mobile computing device;
send a request to a web service, the request describing the received user input;
receive, from the web service, at least one action URI, the action URI identifying one or more corresponding native tasks, the one or more corresponding native tasks specifying at least one resource local to the mobile computing device; and
provide the received action URI to at least one of the plurality of applications executing on the mobile computing device, the at least one of the plurality of applications performing, subject to the set of blocked action URIs stored in the memory area, the one or more corresponding native tasks involving the at least one resource.

2. The system of claim 1, wherein the processor is further programmed to receive an updated set of blocked action URIs for storage in the memory area.

3. The system of claim 1, wherein the received user input indicates a data type.

4. The system of claim 1, wherein the processor is programmed to provide the received action URI by providing the received action URI to the at least one of the plurality of applications without re-installing the at least one of the plurality of applications.

5. The system of claim 1, wherein the received action URI includes hosted user interface (UI) elements.

6. The system of claim 5, wherein the hosted UI elements include a pre-defined template for a UI for linking the received user input and the one or more corresponding native tasks.

7. The system of claim 5, wherein the hosted UI elements include hypertext markup language (HTML) data for a UI for linking the received user input and the one or more corresponding native tasks.

8. The system of claim 1, wherein the processor is programmed to provide the received action URI to the at least one of the plurality of applications executing on the mobile computing device to configure user interface interaction on the mobile computing device without re-installing installed code associated with the at least one of the plurality of applications executing on the mobile computing device.

9. The system of claim 1, wherein the processor is programmed to provide the received action URI to the at least one of the plurality of applications executing on the mobile computing device to dynamically configure a user interface of the mobile computing device using data from the web service.

10. A method comprising:
receiving, by a user computing device, user input from an application executing on the user computing device;
sending a request to a web service, the request describing the received user input;
receiving, from the web service, at least one action uniform resource identifier (URI), the action URI identifying one or more corresponding native tasks for execution by the user computing device, the native task specifying at least one resource local to the user computing device; and
providing, by the user computing device, the received action URI to the application, the application performing the native tasks involving the resource.

11. The method of claim 10, wherein providing the received action URI configures the application without modifying code associated with an installed version of the application.

12. The method of claim 10, wherein sending the request and receiving the at least one action URI are performed without notifying a user of the user computing device.

13. The method of claim 10, wherein receiving the action URI includes receiving hosted user interface (UI) elements for access by the application, the hosted UI elements linking the received user input to the resource.

14. The method of claim 10, wherein receiving the action URI includes receiving a pre-defined user interface (UI) template for display by the application to a user of the user computing device, the pre-defined UI template linking the received user input to the resource.

15. One or more computer storage media embodying computer-executable components, said components comprising:
a link component that when executed causes at least one processor to define a plurality of action uniform resource identifiers (URIs), each of the action URIs corresponding to a task to be executed by a user computing device, the task involving at least one resource local to the user computing device;
a communications interface component that when executed causes at least one processor to receive a request from the user computing device, the request including a state of the user computing device; and
a configuration component that when executed causes at least one processor to identify, based on the state of the user computing device, at least one of the plurality of action URIs defined by the link component,
wherein the communications interface component further provides the at least one of the plurality of action URIs identified by the configuration component to the user computing device, the user computing device executing the task corresponding to the provided at least one of the plurality of action URIs involving the at least one resource local to the user computing device.

16. The computer storage media of claim 15, wherein the communications interface component further provides a set of allowed action URIs to the user computing device, the set of allowed action URIs identifying which tasks are allowed to be executed by the user computing device.

17. The computer storage media of claim 15, wherein the communications interface component further provides a set of blocked action URIs to the user computing device, the set of blocked action URIs identifying which tasks are prohibited from execution by the user computing device.

18. The computer storage media of claim 17, wherein the user computing device executes the corresponding task subject to the set of blocked action URIs provided by the communications interface component.

19. The computer storage media of claim 15, wherein the communications interface component receives the request that includes user input received by the user computing device and/or a status of the resources local to the user computing device.

20. The computer storage media of claim 15, wherein the communications interface component provides the at least one of the plurality of action URIs to the user computing device without publishing an update to an installed application on the user computing device.
